(19) United States
(12) Patent Application Publication
(10) Pub. No.: US 2019/0196563 A1
(43) Pub. Date: Jun. 27, 2019

(54) Cost-Effective Clock Structure For Digital Systems And Methods Thereof

(71) Applicant: MediaTek Inc., Hsinchu City (TW)

(72) Inventor: Ming-Shiang Lai, Hsinchu County (TW)

(21) Appl. No.: 15/852,185

(22) Filed: Dec. 22, 2017

(51) Int. Cl. G06F 1/32

(52) U.S. Cl. CPC G06F 1/324; G06F 1/3287

(57) ABSTRACT

Examples pertaining to a cost-effective clock structure in a digital system are described. When in a low-power mode, a digital circuit operates at a first clock rate, and a counter of a non-stop system timer is incremented using a first clock having the first clock rate. When in a normal mode, the digital circuit operates at a second clock rate greater than the first clock rate, and values of the second clock signal of the second clock between adjacent edges of the first clock signal of the first clock are interpolated using a second clock having the second clock rate. The first clock remains running in both the low-power mode and the normal mode. The second clock is powered down in the low-power mode.

### TECHNICAL FIELD

The present disclosure is generally related to computer system design and, more particularly, to a cost-effective clock structure for digital systems and methods thereof.

### BACKGROUND

Unless otherwise indicated herein, approaches described in this section are not prior art to the claims listed below and are not admitted as prior art by inclusion in this section.

Digital systems usually require a non-stop system timer to provide clocking signals for operations of the digital system. In a portable electronic apparatus that utilizes a digital system and is powered by a portable power supply with a finite capacity, such as a battery, it is imperative to minimize power consumption so as to prolong the life of the battery. Thus, in a digital system, unless necessary the fast clock(s) would be powered down while a very slow clock would be kept running. Accordingly, when in a low-power mode, the clock of the non-stop system timer would be switched to the slow clock. However, the switching may cause clocks to disappear. Moreover, error may be accumulated to an amount that is non-negligible. One approach to cope with the error caused by switching is to compensate for such error. However, as the error may vary due to asynchronization and thus may not be an integer, a design of a compensation circuit may be difficult to implement in a cost-effective way.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose various novel concepts and schemes to address each of the aforementioned issues. Specifically, the present disclosure provides schemes, or proposed solutions, pertaining to a cost-effective clock structure for digital systems.

In one aspect, a method may involve operating a digital circuit at a first clock rate when in a low-power mode, and operating the digital circuit at a second clock rate greater than the first clock rate when in a normal mode. In operating the digital circuit at the first clock rate, the method may involve incrementing a first counter of a non-stop system timer using a first clock having the first clock rate. In operating the digital circuit at the second clock rate, the method may involve interpolating, using a second clock having the second clock rate, values of a second clock signal of the second clock between adjacent edges of a first clock signal of the first clock. The first clock may remain running in both the low-power mode and the normal mode. The second clock may be powered down in the low-power mode.

In one aspect, an apparatus may include a non-stop system timer, a digital circuit, and a central processing unit (CPU). The non-stop system timer may include a first counter, and may be capable of outputting a system timer clock signal based on either a first clock having a first clock rate or a second clock having a second clock rate greater than the first clock rate. The digital circuit may be capable to perform digital operations according to the system timer clock signal. The CPU may be capable of controlling the non-stop system timer and the digital circuit to operate either in a low-power mode at the first clock rate or in a normal mode at the second clock rate. When in the low-power mode, the non-stop system timer may increment the first counter using the first clock. When in the normal mode, the non-stop system timer may interpolate, using a second clock having the second clock rate, values of a second clock signal of the second clock between adjacent edges of a first clock signal of the first clock. The first clock may remain running in both the low-power mode and the normal mode. The second clock may be powered down in the low-power mode.

It is noteworthy that, although certain clock rates (e.g., 32.768 KHz and 26 MHz) and values of integers (e.g., 793 and 794) are used in the description below, such examples are for solely for illustrative purposes and are not intended to limit the scope of the present disclosure in any way or fashion.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example clock structure and operations thereof in accordance with an implementation of the present disclosure.

FIG. 2 is a block diagram of an example apparatus in accordance with an implementation of the present disclosure.

FIG. 3 is a flowchart of an example process in accordance with an implementation of the present disclosure.

FIG. 4 is an example code that varies an integer used to increment a counter in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

In various implementations of a cost-efficient clock structure in accordance with the present disclosure, a frequency of a fast clock source may not be controlled by voltage and thus may be easily affected by environmental elements, such as temperature for example. A slow clock at a much lower frequency, or clock rate, may be generated from the fast clock, and the slow clock may be adjusted by referring to an accurate time, such as mobile networks and/or the Global Positioning System (GPS) for example. Accordingly, the slow clock may be much more accurate than the fast clock, and the fast clock may be used to interpolate values at a higher resolution between clock edges of the slow clock. Thus, when it is necessary to operate in a normal mode for a relatively long time, the cost-efficient clock structure in accordance with the present disclosure would not be affected by inaccuracy in the fast clock while a system timer in the prior art would be.

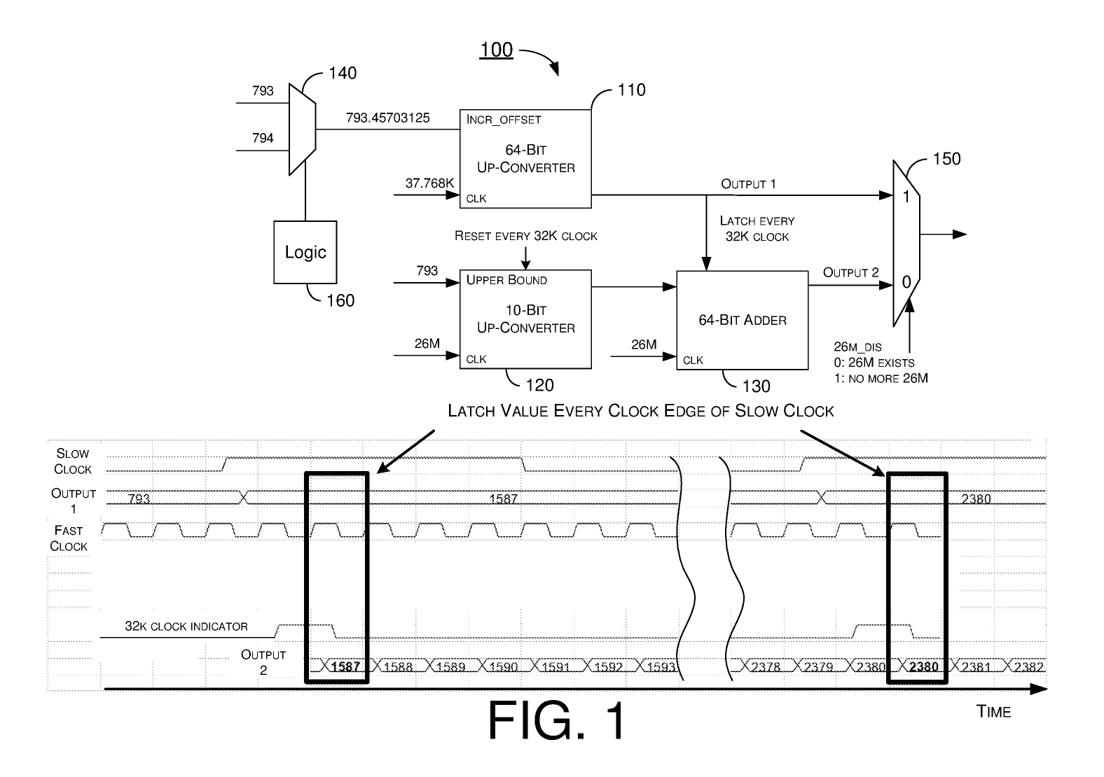

FIG. 1 illustrates an example clock structure 100 and operations thereof in accordance with an implementation of the present disclosure. Specifically, part (A) of FIG. 1 illustrates a block diagram of clock structure 100, and part (B) of FIG. 1 illustrates example timing diagrams of various clock signals and output signals.

Referring to part (A) of FIG. 1, clock structure 100 may include an up counter 110, an up counter 120, an adder 130, a multiplexer 140 and another multiplexer 150. Up counter 110 may be, for example and without limitation, a 64-bit up counter. Up counter 120 may be, for example and without limitation, a 10-bit up counter. Adder 130 may be, for example and without limitation, a 64-bit adder. Up counter 110 may operate at a clock rate of a slow clock (e.g., 32.768 KHz), while up counter 120 and adder 130 may operate at a clock rate of a fast clock (e.g., 26 MHz). Clock structure 100 may also include a logic 160, which may be implemented in the form of hardware and/or software.

Multiplexer 140 may have a first integer (e.g., 793) and a second integer (e.g., 794) as inputs, and may be controlled by logic 160 to output either the first integer or the second integer at a given time. The output of multiplex 140 may be used as an input to up counter 110, which may increment the value of a previous input by the value of a current input at a pace according to the clock rate of the slow clock. The output of up counter 110 is provided as one of two inputs to multiplexer 150.

For instance, when multiplexer 140 first outputs the first integer 793, with up counter 110 starting at a value of 0, the value 793 is taken as input and then incremented by 0 to generate an output of up counter 110 having a value of 793. Assuming multiplexer 140 next outputs the second integer 794, with up counter 110 at the value of 793, the value of 794 is taken as input and then incremented by 793 to generate an output of up counter 110 having a value of 1587.

During operation, clock structure 100 may operate in either a low-power mode or a normal mode at any given time. When in the low-power mode, up counter 120 and adder 130 may be inactive or otherwise powered down, and the fast clock may also be powered down. When in the normal mode, up counter 120 and adder 130 may be active or otherwise in operation at the clock rate of the fast clock. Thus, when in the low-power mode, the output of multiplexer 150 is the output of up counter 110, since up counter 120 and adder 130 are inactive or otherwise powered down. When in the normal mode, the output of multiplexer 150 can be either the output of up counter 110 (labeled as “Output 1” in FIG. 1) or the output of adder 130 (labeled as “Output 2” in FIG. 1).

Up counter 120 may receive a constant integer (e.g., 793) as input, and may increment a value starting at 0 by 1 at a time up to the value of the constant integer at a pace according to the clock rate of the fast clock. The output of up counter 120 is provided as an input to adder 130. The value of up counter 120 may be reset to 0 every clock cycle of the slow clock (e.g., 32.768 KHz). Adder 130 may latch the output of up counter 110 at the clock rate of the slow clock, and may add the latched value to the output of up counter 120 to provide an output of adder 130 having a higher resolution than that of the output of up counter 110. The output of adder 130 is the other input of the two inputs to multiplexer 150.

For instance, when up counter 110 outputs the value of 1587, this value is latched by adder 130 to be added to the output of up counter 120. As the output of up counter 120 varies from 0 to 793, the output of adder 130 varies from 1587 to 2380. Thus, when in the low-power mode, the resolution of the output of multiplexer 150 is relatively low as the value varies as step-changes from 793 to 1587 to 2380 and so on. When in the normal mode, the resolution of the output of multiplexer 150 can have a much higher resolution as the value can vary at a much granular or finer resolution.

### Illustrative Implementations

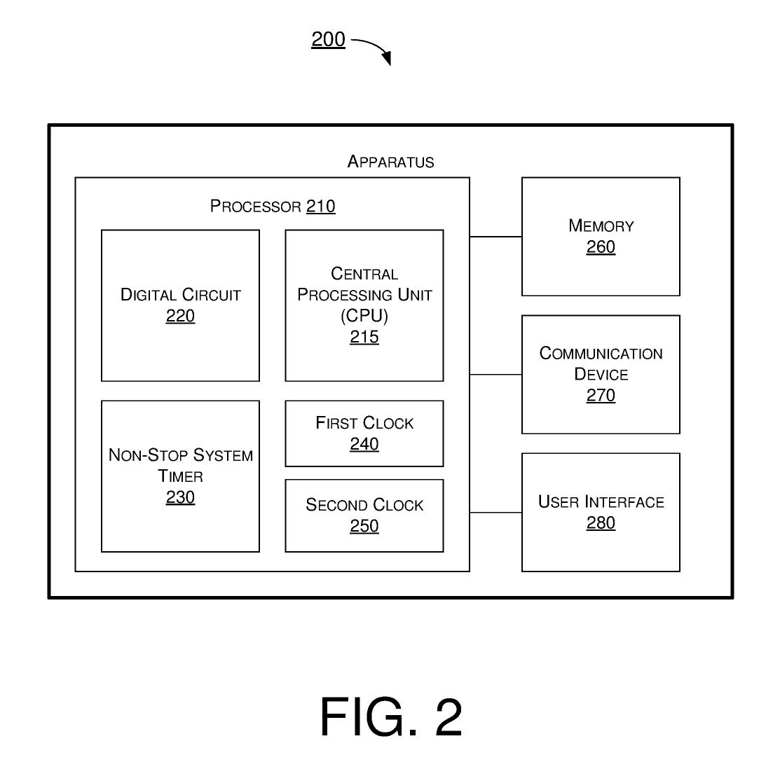

FIG. 2 illustrates an example apparatus 200 in accordance with an implementation of the present disclosure. Apparatus 200 may perform various functions to implement schemes, techniques, processes and methods described herein pertaining to a cost-effective clock structure for digital systems, including the various schemes described above with respect to clock structure 100 as well as process 300.

Apparatus 200 may be a part of an electronic apparatus, which may be a portable or mobile apparatus, a wearable apparatus, a wireless communication apparatus or a computing apparatus. For instance, apparatus 200 may be implemented in or as a smartphone, a smartwatch, a personal digital assistant, a digital camera, or a computing equipment such as a tablet computer, a laptop computer or a notebook computer. Apparatus 200 may also be a part of a machine type apparatus, which may be an Internet-of-Things (loT) apparatus such as an immobile or a stationary apparatus, a home apparatus, a wire communication apparatus or a computing apparatus. For instance, apparatus 200 may be implemented in a smart thermostat, a smart fridge, a smart door lock, a wireless speaker or a home control center. Alternatively, apparatus 200 may be implemented in the form of one or more integrated-circuit (IC) chips such as, for example and without limitation, one or more single-core processors, one or more multi-core processors, or one or more complex-instruction-set-computing (CISC) processors. Apparatus 200 may include at least some of those components shown in FIG. 2 such as a processor 210, for example. Apparatus 200 may further include one or more other components not pertinent to the proposed scheme of the present disclosure (e.g., internal power supply and/or display device) and, thus, such component(s) of apparatus 200 are neither shown in FIG. 2 nor described below in the interest of simplicity and brevity.

In one aspect, processor 210 may be implemented in the form of one or more single-core processors, one or more multi-core processors, or one or more CISC processors. That is, even though a singular term “a processor” is used herein to refer to processor 210, processor 210 may include multiple processors in some implementations and a single processor in other implementations in accordance with the present disclosure. In another aspect, processor 210 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 210 is a special-purpose machine specifically designed, arranged and configured to perform specific tasks pertaining to a cost-effective clock structure for digital systems in accordance with various implementations of the present disclosure.

In some implementations, apparatus 200 may also include a memory 260 coupled to processor 210 and capable of being accessed by processor 210 and storing data therein. Memory 260 may include a type of random-access memory (RAM) such as dynamic RAM (DRAM), static RAM (SRAM), thyristor RAM (T-RAM) and/or zero-capacitor RAM (Z-RAM). Alternatively or additionally, memory 260 may include a type of read-only memory (ROM) such as mask ROM, programmable ROM (PROM), erasable programmable ROM (EPROM) and/or electrically erasable programmable ROM (EEPROM). Alternatively or additionally, memory 260 may include a type of non-volatile random-access memory (NVRAM) such as flash memory, solid-state memory, ferroelectric RAM (FeRAM), magnetoresistive RAM (MRAM) and/or phase-change memory.

In some implementations, apparatus 200 may additionally include a communication device 270 coupled to processor 210 and capable of transmitting and receiving data wirelessly and/or via wired medium(s). In some implementations, communication device 270 may be capable of wirelessly transmitting and receiving signals and data based on, for example and without limitation, one or more Long Term Evolution (LTE)-related standards, one or more IEEE 802.11-related standards (e.g., Wi-Fi), Bluetooth, Near Field Communication (NFC), infrared, ultrasound and/or any other applicable communication specifications, protocols and standards.

In some implementations, apparatus 200 may further include a user interface 280 coupled to processor 210 and capable of receiving user inputs and providing information to one or more users. In some implementations, user interface 280 may include, for example and without limitation, a touch-sensing panel, a touch-sensing pad, a display, a keyboard, a keypad, a mouse, a microphone, one or more speakers, one or more buttons and/or one or more dials.

In some implementations, processor 210 may include a central processing unit (CPU) 215, a digital circuit 220 and a non-stop system timer 230. In some implementations, processor 210 may also include a first clock 240 and a second clock 250. First clock 240 may have a first clock rate, and may be a slow clock having a slow clock rate (e.g., 32.768 KHz). Second clock 250 may have a second clock rate, and may be a fast clock having a fast clock rate (e.g., 26 MHz). Each of first clock 240 and second clock 250 may provide a respective clock signal (e.g., a slow clock signal and a fast clock signal) to non-stop system timer 220.

CPU 215 may be capable of controlling operations of digital circuit 220 and non-stop system timber 230. For instance, CPU 215 may determine whether digital circuit 220 is to operate in a low-power mode or in a normal mode. Digital circuit 220 may be capable of performing various operations such as arithmetic operations, calculations, permutations and logic operations. Non-stop system timer 230 may be an example implementation of clock structure 100. That is, at least a portion of non-stop system timer 230 may be designed, configured or otherwise structured to function and perform operations as described above with respect to clock structure 100. The following is a description of example functions and operations of the components of processor 210.

In some implementations, non-stop system timer 220 may include a first counter (e.g., up counter 110). Non-stop system timer 220 may be capable of outputting a system timer clock signal based on either first clock 240 having a first clock rate (e.g., 32.768 KHz) or second clock 250 having a second clock rate (e.g., 26 MHz) greater than the first clock rate. When in the low-power mode, non-stop system timer 220 may increment the first counter using first clock 240. When in the normal mode, non-stop system timer 220 may, using second clock 250, interpolate values of a second clock signal of second clock 250 between adjacent edges of a first clock signal of first clock 240. First clock 240 may remain running in both the low-power mode and the normal mode, and second clock 250 may be powered down in the low-power mode.

In some implementations, in incrementing the first counter of non-stop system timer 220 using first clock 240, non-stop system timer 220 may perform a number of operations. For instance, non-stop system timer 220 may increment a value of the first counter by an integer at the first clock rate (e.g., incrementing up counter 110 at 32.768 KHz). Additionally, non-stop system timer 220 may output the value of the first counter as a value of non-stop system timer 220.

In some implementations, in incrementing the value of the first counter by the integer, non-stop system timer 220 may increment the value of the first counter by a varying integer. Moreover, in incrementing the value of the first counter by the varying integer, non-stop system timer 220 may alternate a value of the varying integer between a first integer and a second integer such that over a period of time the value of the first counter is incremented by a rational number having a value between the first integer and the second integer. In some implementations, the period of time may be defined by an accumulated count of clock cycles of first clock 240, and the accumulated count may be reset when the accumulated count reaches a predefined count. For example, non-stop system timer 220 may alternate the value of the varying integer between 793 and 794 such that, over a period of time (e.g., when the accumulated count reaches 256 or another integer), in effect and on average the first counter is incremented by a rational number of 793.45703125, where the rational number may be a ratio of the second clock rate to the first clock rate (e.g., 26 MHz/32.768 KHz=793.45703125).

In some implementations, in alternating the value of the varying integer between the first integer and the second integer, non-stop system timer 220 may perform a number of operations. For instance, non-stop system timer 220 may set the value of the varying integer to the first integer (e.g., 793) when the accumulated count of clock cycles of first clock 240 is an even number or one of a plurality of predefined numbers. Moreover, non-stop system timer 220 may set the value of the varying integer to the second integer (e.g., 794) when the accumulated count of clock cycles of first clock 240 is an odd number and not any of the plurality of predefined numbers (e.g., numbers such as 23, 47, 69, 93, 115, 139, 161, 185, 207, 231 and/or 253).

In some implementations, non-stop system timer 220 may also include a second counter (e.g., up counter 120). In interpolating the values of the second clock signal of second clock 250 between adjacent edges of the first clock signal of first clock 240, non-stop system timer 220 may increment a value of the second counter by an integer at the second clock rate. Additionally, non-stop system timer 220 may output the value of the second counter. In some implementations, the value of the second counter may be reset to zero at the first clock rate. For example, when the first clock rate is 32.768 KHz, the value of up counter 120 may be reset to 0 every 32.768 KHz clock cycle.

In some implementations, non-stop system timer 220 may further include an adder (e.g., adder 130). In interpolating values of the second clock signal of second clock 250 between adjacent edges of the first clock signal of first clock 240, non-stop system timer 220 may increment a value of the adder by the outputted value of the second counter at the second clock rate. Moreover, non-stop system timer 220 may output the value of the adder as a value of non-stop system timer 220.

In some implementations, in interpolating the values of the second clock signal of second clock 250 between adjacent edges of the first clock signal of first clock 240, non-stop system timer 220 may latch the outputted value of the first counter at the first clock rate. In incrementing the value of the adder by the outputted value of the second counter at the second clock rate, non-stop system timer 220 may increment the value of the adder with the outputted value of the first counter from the latching as a starting value of the adder. For example, when the outputted value of up counter 110 is 1587, the value 1587 is used as the starting value for adder 130. Accordingly, an output of the adder would be a value incremented from 1587 at a rate equal to the second clock rate.

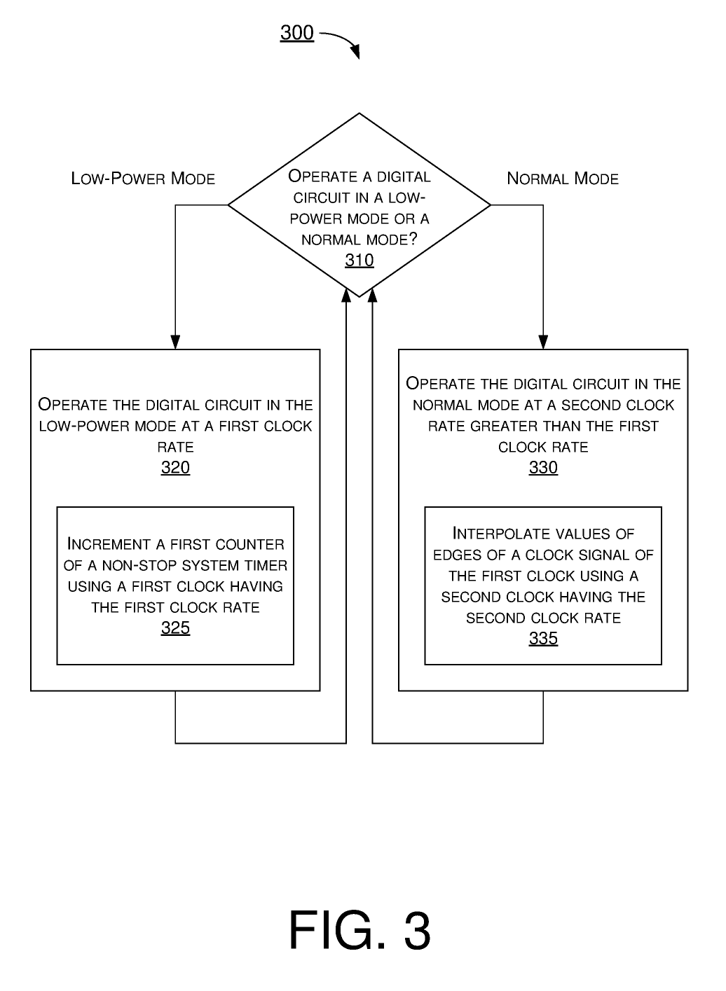

FIG. 3 illustrates an example process 300 in accordance with an implementation of the present disclosure. Process 300 may represent an aspect of implementing the proposed concepts and schemes such as one or more of the various schemes described above pertaining to a cost-effective clock structure for digital systems. More specifically, process 300 may represent an example implementation of the clock structure 100. Process 300 may include one or more operations, actions, or functions as illustrated by one or more of blocks 310, 320 and 330 as well as sub-blocks 325 and 335. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by or in apparatus 200 as well as any variations thereof. Solely for illustrative purposes and without limiting the scope, process 300 is described below in the context of apparatus 200. Process 300 may begin at block 310.

At 310, process 300 may involve processor 210 of apparatus 200 determining whether to operate digital circuit 220 in a low-power mode or a normal mode. Process 300 may proceed from 310 to 320.

At 320, process 300 may involve processor 210 operating digital circuit 220 at a first clock rate (e.g., 32.768 KHz) in response to a determination to operate digital circuit 220 in the low-power mode. Process 300 may proceed from 320 back to 310 to repeat the process.

At 330, process 300 may involve processor 210 operating digital circuit 220 at a second clock rate (e.g., 26 MHz) greater than the first clock rate in response to a determination to operate digital circuit 220 in the normal mode. Process 300 may proceed from 330 back to 310 to repeat the process.

In operating digital circuit 220 in the various modes, process 300 may involve processor 210 performing various operations such as those illustrated in sub-blocks 325 and 335.

At 325, process 300 may involve processor 210 incrementing a first counter of non-stop system timer 230 using a first clock (e.g., a slow clock) having the first clock rate. The first clock may remain running in both the low-power mode and the normal mode.

At 335, process 300 may involve processor 210 interpolating, using a second clock (e.g., a fast clock) having the second clock rate, values of a second clock signal of the second clock between adjacent edges of a first clock signal of the first clock. The second clock may be powered down in the low-power mode. The first clock may be more accurate than the second clock.

In some implementations, in incrementing the first counter of non-stop system timer 230 using the first clock having the first clock rate, process 300 may involve processor 210 incrementing a value of the first counter by an integer at the first clock rate. Additionally, process 300 may involve processor 210 outputting the value of the first counter as a value of non-stop system timer 230.

In some implementations, in incrementing the value of the first counter by the integer, process 300 may involve processor 210 incrementing the value of the first counter by a varying integer.

In some implementations, in incrementing the value of the first counter by the varying integer, process 300 may involve processor 210 alternating a value of the varying integer between a first integer (e.g., 793) and a second integer (e.g., 794) such that over a period of time the value of the first counter is incremented by a rational number (e.g., 793.45703125) having a value between the first integer and the second integer. In some implementations, the rational number may be a ratio of the second clock rate to the first clock rate (e.g., 26 MHz/32.768 KHz=793.45703125).

In some implementations, the period of time may be defined by an accumulated count of clock cycles of the first clock. Moreover, the accumulated count may be reset when the accumulated count reaches a predefined count (e.g., 256 or another integer).

In some implementations, in alternating the value of the varying integer between the first integer and the second integer, process 300 may involve processor 210 setting the value of the varying integer to the first integer when the accumulated count of clock cycles of the first clock is an even number or one of a plurality of predefined numbers (e.g., numbers such as 23, 47, 69, 93, 115, 139, 161, 185, 207, 231 and/or 253). Furthermore, process 300 may involve processor 210 setting the value of the varying integer to the second integer when the accumulated count of clock cycles of the first clock is an odd number and not any of the plurality of predefined numbers.

In some implementations, in interpolating the values of the second clock signal of the second clock between adjacent edges of the first clock signal of the first clock, process 300 may involve processor 210 incrementing a value of a second counter by an integer at the second clock rate. Moreover, process 300 may involve processor 210 outputting the value of the second counter. In some implementations, the value of the second counter may be reset to zero at the first clock rate.

In some implementations, in interpolating the values of the second clock signal of the second clock between adjacent edges of the first clock signal of the first clock, process 300 may also involve processor 210 incrementing a value of an adder by the outputted value of the second counter at the second clock rate. Additionally, process 300 may involve processor 210 outputting the value of the adder as a value of non-stop system timer 230.

In some implementations, in interpolating the values of edges of the clock signal of the first clock using the second clock having the second clock rate, process 300 may further involve processor 210 latching the outputted value of the first counter at the first clock rate. Moreover, in incrementing the value of the adder by the outputted value of the second counter at the second clock rate, process 300 may involve processor 210 incrementing the value of the adder with the outputted value of the first counter from the latching as a starting value of the adder.

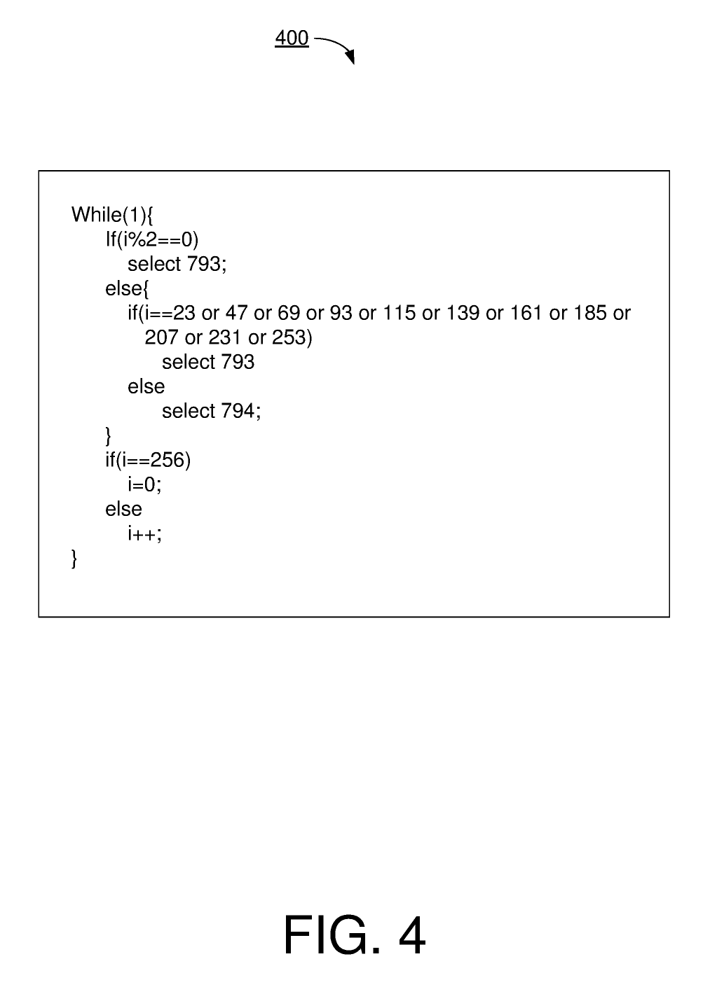

FIG. 4 is an example code 400 that varies an integer used to increment a counter in accordance with an implementation of the present disclosure. Code 400 may be an example implementation of logic 160.

In this example, the varying integer used to increment a counter (e.g., up counter 110) is alternated between 793 and 794, and the alternating between 793 and 794 depends on the value of an accumulated count of clock cycles of a clock (e.g., a slow clock at 32.768 KHz). More specifically, when the accumulated count of clock cycles of the clock is an even number or one of a plurality of predefined numbers (e.g., numbers such as 23, 47, 69, 93, 115, 139, 161, 185, 207, 231 and/or 253), the varying integer is set to 793. Otherwise, when the accumulated count of clock cycles of the clock is an odd number and not any one of the plurality of predefined numbers, the varying integer is set to 794. Accordingly, over a period of time (e.g., when the accumulated count reaches 256 or another integer), in effect and on average the counter (e.g., up counter 110) is incremented by a rational number of 793.45703125, which may be a ratio of a fast clock rate to a slow clock rate (e.g., 26 MHz/32.768 KHz=793.45703125).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining whether to operate a digital circuit in a low-power mode or a normal mode;
responsive to a determination to operate the digital circuit in the low-power mode, operating the digital circuit at a first clock rate; and
responsive to a determination to operate the digital circuit in the normal mode, operating the digital circuit at a second clock rate greater than the first clock rate,
wherein the operating of the digital circuit at the first clock rate comprises incrementing a first counter of a non-stop system timer using a first clock having the first clock rate,
wherein the operating of the digital circuit at the second clock rate comprises interpolating, using a second clock having the second clock rate, values of a second clock signal of the second clock between adjacent edges of a first clock signal of the first clock,
wherein the first clock remains running in both the low-power mode and the normal mode, and
wherein the second clock is powered down in the low-power mode.

2. The method of claim 1, wherein the incrementing of the first counter of the non-stop system timer using the first clock having the first clock rate comprises:
incrementing a value of the first counter by an integer at the first clock rate; and
outputting the value of the first counter as a value of the non-stop system timer.

3. The method of claim 2, wherein the incrementing of the value of the first counter by the integer comprises incrementing the value of the first counter by a varying integer.

4. The method of claim 3, wherein the incrementing of the value of the first counter by the varying integer comprises alternating a value of the varying integer between a first integer and a second integer such that over a period of time the value of the first counter is incremented by a rational number having a value between the first integer and the second integer.

5. The method of claim 4, wherein the period of time is defined by an accumulated count of clock cycles of the first clock, and wherein the accumulated count is reset when the accumulated count reaches a predefined count.

6. The method of claim 5, wherein the alternating of the value of the varying integer between the first integer and the second integer comprises:
setting the value of the varying integer to the first integer when the accumulated count of clock cycles of the first clock is an even number or one of a plurality of predefined numbers; and
setting the value of the varying integer to the second integer when the accumulated count of clock cycles of the first clock is an odd number and not any of the plurality of predefined numbers.

7. The method of claim 2, wherein the interpolating of the values of the second clock signal of the second clock between adjacent edges of the first clock signal of the first clock comprises:
incrementing a value of a second counter by an integer at the second clock rate; and
outputting the value of the second counter.

8. The method of claim 7, wherein the value of the second counter is reset to zero at the first clock rate.

9. The method of claim 7, wherein the interpolating of the values of the second clock signal of the second clock between adjacent edges of the first clock signal of the first clock further comprises:
incrementing a value of an adder by the outputted value of the second counter at the second clock rate; and
outputting the value of the adder as a value of the non-stop system timer.

10. The method of claim 9, wherein the interpolating of the values of the second clock signal of the second clock between adjacent edges of the first clock signal of the first clock further comprises:
latching the outputted value of the first counter at the first clock rate,
wherein the incrementing of the value of the adder by the outputted value of the second counter at the second clock rate comprises incrementing the value of the adder with the outputted value of the first counter from the latching as a starting value of the adder.

11. An apparatus, comprising:
a non-stop system timer comprising a first counter, the non-stop system timer capable of outputting a system timer clock signal based on either a first clock having a first clock rate or a second clock having a second clock rate greater than the first clock rate;
a digital circuit capable to perform digital operations according to the system timer clock signal;
a central processing unit (CPU) capable of controlling the non-stop system timer and the digital circuit to operate either in a low-power mode at the first clock rate or in a normal mode at the second clock rate,
wherein, when in the low-power mode, the non-stop system timer increments the first counter using the first clock,
wherein, when in the normal mode, the non-stop system timer interpolates, using a second clock having the second clock rate, values of a second clock signal of the second clock between adjacent edges of a first clock signal of the first clock,
wherein the first clock remains running in both the low-power mode and the normal mode, and
wherein the second clock is powered down in the low-power mode.

12. The apparatus of claim 11, wherein, in incrementing the first counter of the non-stop system timer using the first clock, the non-stop system timer performs operations comprising:
incrementing a value of the first counter by an integer at the first clock rate; and
outputting the value of the first counter as a value of the non-stop system timer.

13. The apparatus of claim 12, wherein, in incrementing the value of the first counter by the integer, the non-stop system timer increments the value of the first counter by a varying integer.

14. The apparatus of claim 13, wherein, in incrementing the value of the first counter by the varying integer, the non-stop system timer alternates a value of the varying integer between a first integer and a second integer such that over a period of time the value of the first counter is incremented by a rational number having a value between the first integer and the second integer.

15. The apparatus of claim 14, wherein the period of time is defined by an accumulated count of clock cycles of the first clock, and wherein the accumulated count is reset when the accumulated count reaches a predefined count.

16. The apparatus of claim 15, wherein, in alternating the value of the varying integer between the first integer and the second integer, the non-stop system timer performs operations comprising:
setting the value of the varying integer to the first integer when the accumulated count of clock cycles of the first clock is an even number or one of a plurality of predefined numbers; and
setting the value of the varying integer to the second integer when the accumulated count of clock cycles of the first clock is an odd number and not any of the plurality of predefined numbers.

17. The apparatus of claim 12, wherein the non-stop system timer further comprises a second counter, and wherein, in interpolating the values of the second clock signal of the second clock between adjacent edges of the first clock signal of the first clock, the non-stop system timer performs operations comprising:
incrementing a value of the second counter by an integer at the second clock rate; and
outputting the value of the second counter.

18. The apparatus of claim 17, wherein the value of the second counter is reset to zero at the first clock rate.

19. The apparatus of claim 17, wherein the non-stop system timer further comprises an adder, and wherein, in interpolating the values of the second clock signal of the second clock between adjacent edges of the first clock signal of the first clock, the non-stop system timer performs operations comprising:
incrementing a value of the adder by the outputted value of the second counter at the second clock rate; and
outputting the value of the adder as a value of the non-stop system timer.

20. The apparatus of claim 19, wherein, in interpolating the values of the second clock signal of the second clock between adjacent edges of the first clock signal of the first clock, the non-stop system timer latches the outputted value of the first counter at the first clock rate, and wherein, in incrementing the value of the adder by the outputted value of the second counter at the second clock rate, the non-stop system timer increments the value of the adder with the outputted value of the first counter from the latching as a starting value of the adder.
